(19) United States
(12) Patent Application Publication
(10) Pub. No.: US 2003/0149515 A1
(43) Pub. Date: Aug. 7, 2003

(54) System and method for monitoring the vehicle dynamics of a motor vehicle

(76) Inventors: Ulrich Hessmert, Schwieberdingen (DE); Jost Brachert, Ditzingen (DE); Helmut Wandel, Markgroeningen (DE); Norbert Polzin, Zaberfeld (DE)

Correspondence Address: KENYON & KENYON, ONE BROADWAY, NEW YORK, NY, 10004, US

(21) Appl. No.: 10/220,384

(22) PCT Filed: Dec. 20, 2001
(86) PCT No.: PCT/DE01/04826

(30) Foreign Application Priority Data
Dec. 30, 2000 (DE) 100 65 776.1

(51) Int. Cl. G06F 17/00

(52) U.S. Cl. 701/29; 701/1

(57) ABSTRACT

A system of monitoring the handling properties of a motor vehicle having at least two wheels (12) includes at least one wheel-force sensor device (10) associated with a wheel (12), which detects at least one wheel-force component of the respective wheel (12) acting essentially between the driving surface and the tire contact area, outputs a signal (Si, Sa) representing the wheel-force component, and includes an evaluation device (14) which processes the signal (Si, Sa) representing the wheel-force component of the wheel (12). The evaluation device (14) determines a yaw moment of the vehicle according to the result of the processing. A corresponding method is also described.

The present invention relates to a system for monitoring the handling properties of a motor vehicle having at least two wheels, including at least one wheel-force sensor device associated with a wheel, which detects at least one wheel-force component of the respective wheel operating essentially between the driving surface and the tire contact area and outputs a signal representing the wheel-force component, and an evaluation device which processes the signal representing the wheel-force component.

The present invention also relates to a method of monitoring the handling properties of a motor vehicle having at least two wheels, including at least the following steps: detecting at least one wheel-force component of the respective wheel operating essentially between the driving surface and the tire contact area, and processing the detected wheel-force component of the wheel.

### BACKGROUND INFORMATION

One variable describing the driving condition of a motor vehicle is its yaw, i.e., a rotation of the vehicle around its vertical axis, i.e., around an axis orthogonal to the longitudinal and transverse directions of the vehicle.

When cornering, rotation of a vehicle around its yaw axis is desired, since cornering is meant specifically to change the orientation of the vehicle in the plane of travel. However, there are numerous other influences that act on a vehicle and may thereby cause unwanted yawing of the vehicle.

One such possible influence which may be named as an example is driving, and in particular deceleration or acceleration, on a split-μ surface. On a split-μ surface, the tires on one side of the car, i.e., the left or the right side, may take advantage of a substantially higher or lower coefficient of friction when transferring force between wheel and driving surface than the tires on the other side of the vehicle.

In such a case, and in additional cases of undesired yaw, it is known for example to intervene in a stabilizing way into the operating state of the vehicle in such a way that the vehicle's tendency to yaw disappears or is reduced to a desired level. In this connection it is known to detect yaw rates and to level out deviations of a detected actual yaw rate from a desired target yaw rate—i.e., to bring the actual condition into proximity with the target condition—within the context of an ESP regulating system. Alternatively or in addition to yaw rate regulation, sideslip angle regulation is also utilized. A disadvantage of the known regulating systems is that detecting the yaw rate as precisely as possible—this is even more true of the sideslip angle—requires the employment of complicated measurement technology using a plurality of different sensors.

In conjunction with antilock brake systems, providing yaw moment reduction or yaw moment buildup delay in order to prevent the vehicle from experiencing an unwanted yawing tendency due to the target braking forces specified for the individual wheels by the ABS regulator is also known. Conventional system modules for yaw moment reduction or yaw moment buildup delay simply reduce or limit the target braking forces prescribed by the ABS regulator, thereby reducing the yawing tendency of the vehicle which may occur under some circumstances when braking.

Although it is possible to reduce the yawing tendency of the vehicle in many cases by using such yaw moment buildup delay system modules, limiting prescribed target braking forces according to pre-defined algorithms does not achieve optimal adaptation of the braking forces to the prevailing external conditions. Additional outside influences, such as different coefficients of friction at the brake linings of the individual wheels, cannot be taken into account in this sort of braking force limitation.

In conjunction with the provision of sensors according to the definition of the species, it is also known that various tire manufacturers are planning to use “intelligent” tires in the future. It will be possible to install new sensors and evaluation circuitry directly on the tire. The use of such tires will allow additional functions, such as measuring the torque acting on the tire longitudinally and transversely to the direction of travel, the tire pressure, or the tire temperature. In this connection it will be possible for example to provide tires in which magnetizable areas or strips having field lines running preferably in the circumferential direction are incorporated into each tire. The magnetization is performed for example by sections, always in the same direction but with opposite orientation, i.e., with alternating polarity. The magnetized strips preferably run near the rim flange or near the tire contact area. Thus the transducers rotate at wheel speed. Corresponding sensing elements are preferably attached firmly to the body at two or more different points in reference to the direction of rotation, and also are located at different radial distances from the axis of rotation. That makes it possible to determine an inner measurement signal and an outer measurement signal. Rotation of the tire can then be recognized from the changing polarity of the measurement signal or signals in the circumferential direction. It is possible to calculate the wheel velocity for example from the extent of roll-off and the change of the inner measurement signal and the outer measurement signal over time.

It has also already been proposed that sensors be placed in the wheel bearing; they may be placed in either the rotating or the static part of the wheel bearing. For example, the bearings may be implemented as microsensors in the form of microswitch arrays. The sensors located on the movable part of the wheel bearing for example measure forces and accelerations and the velocity of rotation of a wheel. This data is compared to electronically stored basic patterns or to data from an equivalent or similar microsensor which is attached to the static part of the wheel bearing.

### ADVANTAGES OF THE INVENTION

The present invention builds on the generic system by having the evaluation device determine a yaw moment of the vehicle according to the result of the processing. It is advantageous that together with detecting the yaw moment the cause of the yawing is detected directly, whereas in the past the yaw rate detected only an effect of this cause. This in itself permits more exact monitoring of the handling of the vehicle than in the past. In addition, the use of measurement methods to detect at least one wheel-force component operating between the area of frictional contact and the driving surface is considerably less complex than detecting the yaw rate according to the related art.

It is possible in principle to deduce the yaw moment operating on the vehicle even from a wheel-force component at a single wheel. However, the accuracy of this approach depends greatly on the design of the vehicle and the load conditions at the moment.

In regard to the accuracy of the detected yaw moment, it is therefore advantageous if wheel-force sensor devices are associated with several wheels, in particular with every wheel of the vehicle.

The yaw moment operating on the vehicle may be determined very well even from one detected circumferential wheel-force component. The circumferential wheel-force is a force acting in the circumferential direction of the wheel. The yaw moment may likewise be determined from detected transverse wheel-forces, however. The transverse wheel-force is essentially a force acting in the tire contact plane, orthogonally to the circumferential wheel-force. Preferably both force components are detected, i.e., circumferential wheel-force and transverse wheel-force, since in this way all force components contributing to the yaw moment are taken into account, which is advantageous for the accuracy of the result of the determination.

Particularly preferentially, the tire contact force, i.e., the wheel-force component acting orthogonally to the tire contact plane, is also measured. Knowing the tire contact forces of every wheel it is possible to determine the locus of the center of gravity of the vehicle, the exact knowledge of which in turn increases the accuracy of the determination of the yaw moment. According to the present invention, however, instead of calculating the location of the center of gravity from the tire contact forces, a location for the center of gravity predefined from the vehicle design and distribution of mass may also be used.

According to one embodiment of the present invention, the torque of the wheel-force components acting on the wheel around a yaw axis that runs through the center of gravity of the vehicle is calculated—first of all for the at least one wheel, preferably for more than one wheel, particularly preferably for every wheel. The yaw moment of the vehicle is then calculated from the sum of all the individual torques. In the event that wheel-force components are detected on only part of the wheels of the vehicle, it is possible to deduce from the detected wheel-force components the undetected wheel-force components operating on the other wheels, for instance using an appropriate characteristic map.

If the system also includes a memory device, the detected yaw moment may be stored there, so that it is available for subsequent control and/or regulation of the handling properties and driving dynamics of the vehicle.

In addition, the system may output a control signal according to the detected yaw moment, it being advantageous for the system to include a control unit that then influences the operating state of the vehicle according to the control signal output.

According to one embodiment of the present invention, the evaluation device may for example determine the difference between the detected actual yaw moment and a predefined or already calculated target yaw moment and induce an influencing of the operating state of the vehicle depending on the difference. According to one aspect of the invention, to prevent minor control interventions the difference may in turn be compared to a predetermined threshold value below which no influence is exerted on the operating state.

As a function of the control signal output, the control unit may then exert a stabilizing effect on the handling properties or the driving condition of the vehicle in a simple way by changing the position of an engine throttle valve and/or by altering the ignition timing and/or by modifying the quantity of fuel injected and/or by changing the brake pressure in at least one of the wheels of the motor vehicle.

It is possible to implement the system with a small number of components, if the control device and/or the evaluation device is or are associated with a device for controlling and/or regulating the handling properties of a motor vehicle, such as an Antilock Brake System, a Traction Control System or an ESP system. Being “associated with” includes the preferred case that the named devices are part of the system.

The advantage of the present invention becomes especially clear in the fact that it is possible to construct a yaw moment regulating circuit on the basis of the actual yaw moment detected, preferably in a device for controlling and/or regulating the handling properties of a motor vehicle, in particular in an Antilock Brake System, a Traction Control System or and ESP system. The yaw moment regulating circuit may compare the detected yaw moment with a target yaw moment, and depending on the comparison may determine target wheel-forces that are to be exerted on at least one wheel by the control unit. With a yaw moment regulating circuit of this sort it is also possible to level out other influences, such as different brake friction coefficients at the individual wheels due to unevenly worn or glazed brake linings.

Particularly advantageously, such a yaw moment regulating circuit may be incorporated into a yaw moment reduction or yaw moment buildup delay regulating circuit described earlier.

For determining the actual yaw moment as accurately as possible, it is necessary to detect the at least one wheel-force component as accurately as possible. Very good results may be determined using a tire sensor device, since there the location of detection and the point of action of the detected force components are very close together, reducing interference.

Alternatively, or else in addition in order to protect the system through redundancies, a wheel bearing sensor device as described earlier may be used. Here too, the detection results are very good because of the spatial proximity of the point of action and the location of detection.

In other words, the present invention is implemented by a system for controlling and/or regulating the handling properties of a motor vehicle having at least one tire and/or one wheel, in which a force sensor is positioned in the tire and/or on the wheel, in particular on the wheel bearing, and as a function of the output signals from the force sensor a yaw moment variable representing the instantaneous yaw moment is determined and this yaw moment variable is used to control and/or regulate the handling properties.

The present invention is refined compared to the generic method by having the method also include a step to determine a yaw moment of the vehicle according to the result of the processing. The method according to the present invention is particularly well suited for embodiment by the system according to the present invention described above. The advantages and advantageous effects described in connection with the system according to the present invention are also achieved through the method according to the present invention, so that reference is made explicitly to the description of the system according to the present invention.

By determining the yaw moment directly from detected wheel-force components, the complexity in terms of measurement technology to determine this variable on a vehicle is reduced significantly.

As already described, it is of great advantage for the accuracy of the determined actual yaw moment if at least one wheel-force component acting between the driving surface and the tire contact area is detected at several wheels, in particular at every wheel of the vehicle. In principle it is sufficient to determine one circumferential wheel-force or one transverse wheel-force, but the accuracy of the detected actual yaw moment is improved significantly if both named wheel-force components are detected. Then all of the wheel-force components that may contribute to the yaw moment of the vehicle are known.

For the reasons stated above, preferably the tire contact force is also detected. For the method when determining the yaw moment, reference is made to the description given in connection with the system according to the present invention.

In order to be able to supply the detected actual yaw moment for subsequent electronic stability regulation, it may be stored in a memory device.

In such a subsequent step, the operating state of the motor vehicle may be influenced according to the detected actual yaw moment, for example according to a comparison of the target and the actual yaw moment.

A reduction in the number of parts, and hence also a reduction of manufacturing and assembly costs, may be achieved by having the influencing of the operating state of the motor vehicle performed by a device for controlling and/or regulating the handling properties of a motor vehicle, such as an Antilock Brake System, a Traction Control System or an ESP system.

According to one aspect of the present invention, the influencing may also be such that first the detected yaw moment is compared to a target yaw moment, and then on the basis of the result of the comparison, for example as described above, target wheel-forces are determined which are to be exerted on at least one wheel. Additional details of preferred embodiments of the method according to the present invention are described in the description of the figures.

Advantageously, the at least one wheel-force component is detected as near as possible to the locus of its action; a primary possibility is the wheel itself, i.e., the detection occurs on a tire or at a bearing.

### DRAWING

Additional details of the invention are described below on the basis of the associated drawing.

FIG. 1 shows a block diagram of a system according to the present invention;

FIG. 2 shows a flow chart of a method according to the present invention;

FIG. 3 shows part of a tire equipped with a tire sidewall sensor;

FIG. 4 shows exemplary signal waveforms for the tire sidewall sensor depicted in FIG. 3;

FIG. 5 shows a system diagram of an ESP system of the related art;

FIG. 6 shows a system diagram of an ESP system according to the present invention;

FIG. 7 shows a system diagram of an Antilock Brake System of the related art; and

FIG. 8 shows a system diagram of an Antilock Brake System according to the present invention.

### DESCRIPTION OF THE EMBODIMENTS

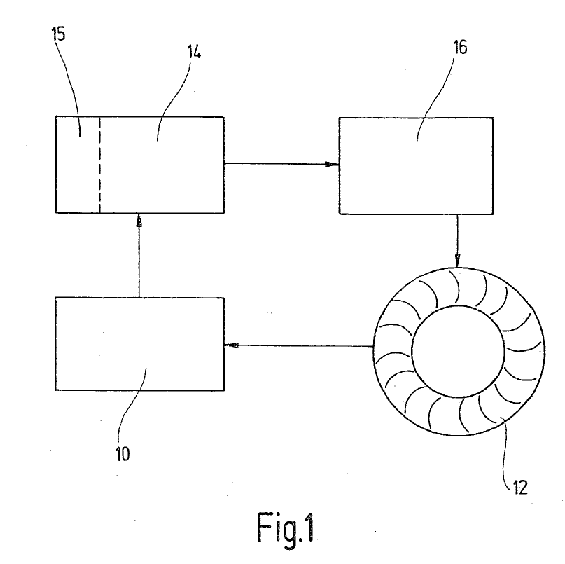

FIG. 1 shows a block diagram of a system according to the present invention. A sensor device 10 is associated with a wheel 12, depicted wheel 12 being shown as representative of the wheels of a vehicle. Sensor device 10 is linked to an evaluation device 14 for processing signals of sensor device 10. Evaluation device 14 includes a memory device 15 for storing detected values. Evaluation device 14 is also linked to a control device 16. This control device 16 in turn is associated with wheel 12.

In the example shown here, sensor device 10 detects the tire contact force, the transverse wheel-force and the circumferential wheel-force of wheel 12. The results of the detection are communicated to evaluation device 14 for further processing. For example, in evaluation device 14 the named wheel-forces are determined from the detected deformation of the tire. This may be done using characteristic curves stored in a memory unit.

In evaluation device 14, the location of the center of gravity of the motor vehicle may be determined from the tire contact forces of the individual wheels. Consequently from the circumferential and transverse wheel-forces of each wheel the respective torque of the wheel-forces around the center of gravity of the vehicle may be determined, and from the sum of these torques finally the instantaneously occurring actual yaw moment of the vehicle.

The actual yaw moment determined in this way is compared in evaluation device 14 to a target yaw moment. If the comparison indicates that a difference between the target and actual yaw moments is greater than a still barely acceptable threshold value, evaluation device 14 determines target wheel-forces which are to be exerted on individual wheels, for example by a braking intervention, and generates a corresponding control signal.

This signal may then be transmitted to a control device 16, so that as a function of the signal an influence may be exerted on the operating state of the vehicle, for example on wheel 12. Such an influence may be exerted in addition to or alternatively to a braking intervention, for example via engine intervention.

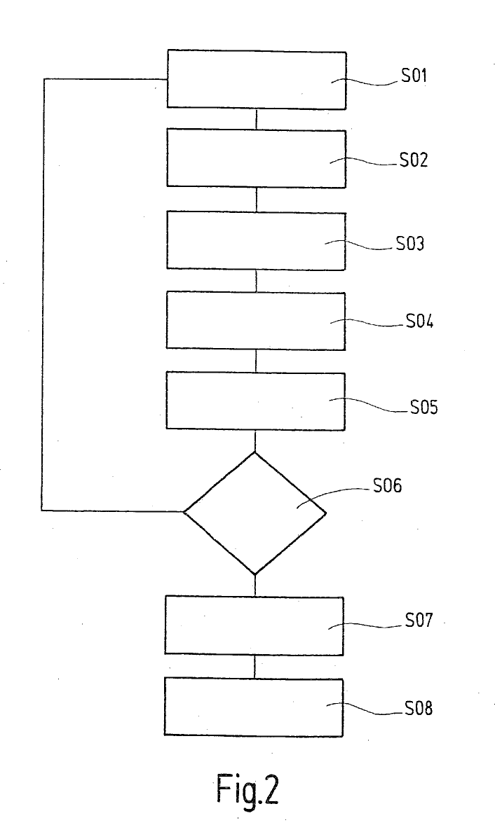

FIG. 2 shows a flow chart of an embodiment of the method according to the present invention within the framework of the present invention, depicting a stabilizing intervention into the operation of the vehicle by the system according to the invention. First the meanings of the individual steps are indicated:

S01: Detection of a deformation of a tire.

S02: Determination of a circumferential, transverse, and contact force of the tire on the driving surface from the detected deformation.

S03: Determining the location of the vehicle center of gravity from the tire contact force of each wheel, preferably in a coordinate system fixedly associated with the vehicle.

S04: Determination of the torque of lateral wheel-force and of circumferential wheel-force of each wheel around a yaw axis running through the center of gravity of the vehicle.

S05: Determination of the actually occurring actual yaw moment of the vehicle from the individual torques of the wheel-forces from Step S04.

S06: Comparison of the actual yaw moment determined in Step S05 with a target yaw moment.

S07: Determining the appropriate measures for an operational invention to bring the actual yaw moment into the proximity of the target yaw moment, and the wheels on where these measures are to be performed.

S08: Performance of the measures.

The procedure shown in FIG. 2 may be carried out in this way or similarly with a rear-wheel-drive or a front-wheel-drive vehicle. In Step S01 for example, a deformation of a tire is measured.

From this deformation, in Step S02 a tire contact force, a circumferential wheel-force and a transverse wheel-force are determined for each wheel. This is done using characteristic curves stored in a memory device which give the correlation between deformations of the tire and the named wheel-forces.

In Step S03 the location of the center of mass of the vehicle is determined from the calculated tire contact force for each wheel.

In Step S04, using the transverse wheel-force and the circumferential wheel-force, a torque around a yaw axis running though the center of gravity of the vehicle is determined with great accuracy for each wheel of the vehicle.

In subsequent Step S05, a-vehicle yaw moment is calculated by summing up the torques acting on each wheel around the yaw axis running through the center of gravity of the vehicle. This is the actual yaw moment of the vehicle actually occurring at that moment.

Then in Step S06 a comparison is performed between a target yaw moment and an actual yaw moment. The target yaw moment may be determined here for example by an ESP regulating device from detected vehicle operating data, using a vehicle model. The comparison sequence may be such for example that the difference between the target and the actual yaw moment is calculated and this difference is compared to a threshold value. If the difference does not exceed the threshold value, the method returns to Step 01 and no intervention into the operating state of the vehicle takes place. If on the other hand the difference exceeds the threshold value, in the subsequent steps a stabilizing intervention into the operating state of the vehicle takes place.

In Step S07, suitable measures are determined for bringing the actual yaw moment into the proximity of the target yaw moment. This may take place for example in two stages, in such a way that first the wheels are selected to which additional braking force is to be applied, or from which a braking force currently exerted is to be removed. In the next step the magnitude of the braking force to be applied or removed is calculated.

Finally, in Step 08 the measures determined in Step S07 are carried out through appropriate control interventions, for example on hydraulic valves.

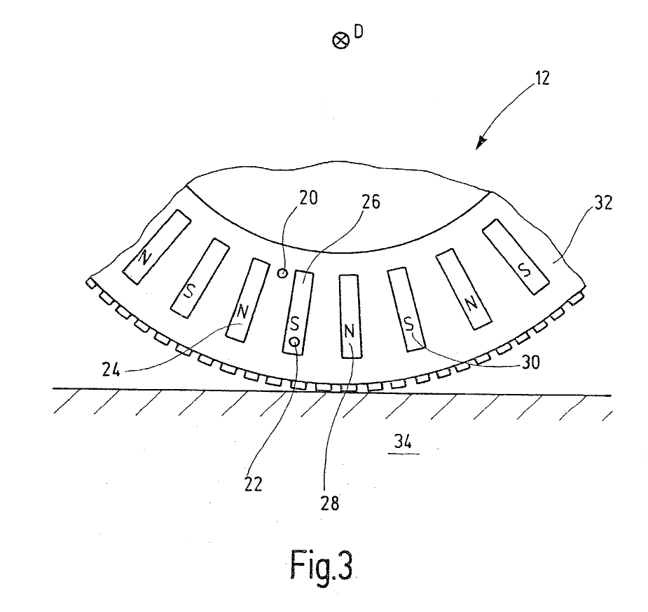

FIG. 3 shows a section of a tire 32 mounted on wheel 12, having a tire sidewall sensor device 20, 22, 24, 26, 28, 30 viewed in the direction of the axis of rotation D of tire 32. Tire sidewall sensor device 20 includes two sensor devices 20, 22, attached firmly to the vehicle body at two different points in the direction of rotation. Sensor devices 20, 22 also each have a different radial distance from the axis of rotation of wheel 32. The sidewall of tire 32 is provided with a plurality of magnetized areas functioning as transducers 24, 26, 28, 30 (strips) running essentially in the radial direction with reference to the rotational axis of the wheel, preferably having field lines running in the circumferential direction. The magnetized areas have alternating magnetic polarity.

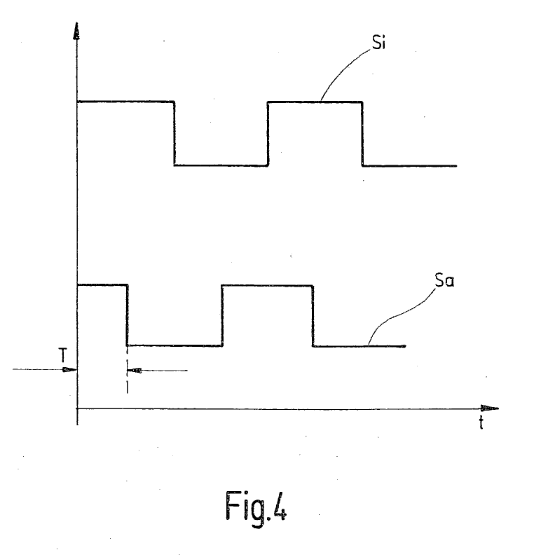

FIG. 4 shows the variation of signal Si of sensor device 20 from FIG. 3, located inside, i.e., closer to the axis of rotation D of wheel 12, and of signal Sa of sensor device 22 from FIG. 3, located outside, i.e., farther away from the axis of rotation of wheel 12. Rotation of tire 32 is recognized from the changing polarity of measurement signals Si and Sa. From the extent of roll-off and the change of signals Si and Sa over time it is possible for example to calculate the wheel speed. Phase shifts between the signals enable determination of torsions in tire 32, and thus for example direct measurement of wheel-forces. Within the framework of the present invention it is of particular advantage if the contact force of tire 32 on road 34 is determinable according to FIG. 3, since it is possible to deduce the lift-off tendency of tires of the motor vehicle directly from this tire contact force in a manner according to the present invention. A tire contact force may be determined from the tire deformation even with the tire at rest.

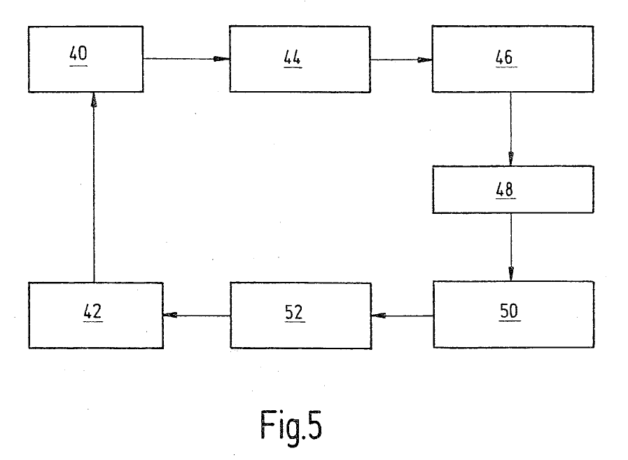

FIG. 5 shows a system representation of a conventional ESP control system. An ESP regulating device 40 receives from driving condition sensors 42 driving condition signals (for example aq, DRS, δ, etc.) which describe the driving condition of the vehicle. From these driving condition signals ESP regulating device 40 determines a target yaw moment which it forwards to a first model module 44. In the first model module a vehicle model and a tire model are stored, on the basis of which target tire forces are calculated from the target yaw moment and are output to a second model module 46. In second model module 46 a hydraulics model is stored, which determines how the brake hydraulics of the vehicle must be activated in order to determine the target tire forces. Second model module 46 then outputs the determined hydraulics activation and the determined valve control signals to a hydraulics assembly 48 which activates the hydraulics in accordance with the signals. This activation produces braking forces on the wheels or tires 50, which in turn causes tire forces to act on vehicle 52. The tire forces are the cause of a change in the movement of the vehicle, which finally is detected in turn by driving condition sensors 42. That closes the ESP regulating circuit.

However, a regulating circuit of this sort has the disadvantage that inaccurate calculations due to inadequate information about parameter changes between hydraulic model and tires can only be compensated via the entire ESP regulating circuit.

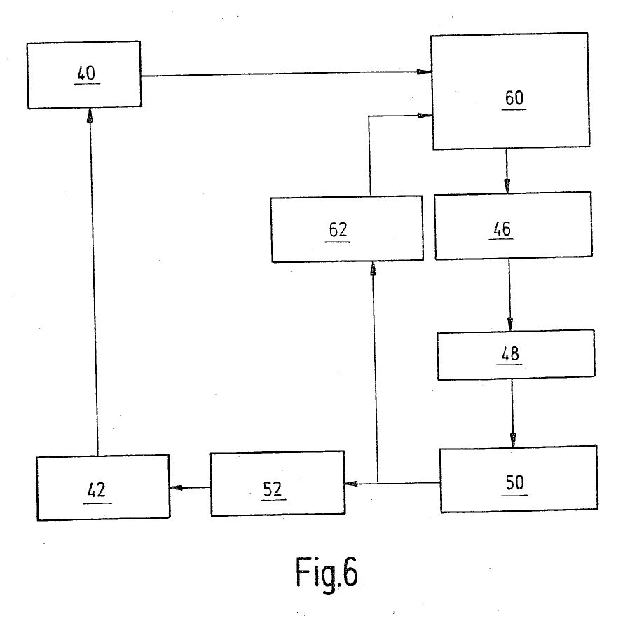

FIG. 6 therefore illustrates a modified ESP regulating circuit which depicts a system according to the present invention. The ESP regulating circuit corresponds in many elements to that in FIG. 5, but there is no first model module 44 present to determine target tire forces from a target yaw moment on the basis of stored vehicle and tire models. Instead, the regulating circuit contains a yaw moment regulating device 60 and a calculation module 62.

Since the ESP regulating circuits in FIG. 5 and 6 are otherwise identical, only the difference will be explained in greater detail below.

The output variable of ESP regulating device 40 is, as before, a target yaw moment determined from driving condition signals. This target yaw moment is input into a yaw moment regulating device 60. In contrast to the ESP regulating circuit of FIG. 5, tire forces of the wheels or tires 50 are now detected and evaluated by a calculation module 62. Calculation module 62 may include for example a wheel-force sensor device and an evaluation device. In calculation module 62 the distances of the centers of gravity of the individual wheels from the center of gravity of the vehicle or from a yaw axis running through the center of gravity of the vehicle may optionally be stored, or may be calculated on the basis of detected tire contact forces. Furthermore, the actual yaw moment which is currently acting on the vehicle is calculated in calculation module 62 on the basis of the detected circumferential wheel-forces and transverse wheel-forces. This actual yaw moment is input into yaw moment regulating device 60.

Yaw moment regulating device 60 processes the target yaw moment and actual yaw moment and determines from them target tire forces for individual wheels or tires or for all wheels or tires of the vehicle, and outputs the target tire forces which have been determined to calculation module 46. The further processing in the ESP regulating circuit then corresponds to that described for FIG. 5.

The processing of the target and actual yaw moments into a target tire force for one or more wheels of the vehicle may proceed according to one aspect of the present invention for example as follows:

The yaw moment regulating device generates a difference between the target yaw moment and actual yaw moment and compares the difference thus determined to a tolerance threshold value. In the event that the threshold value is not reached, the yaw condition of the vehicle is not corrected; but if the difference exceeds the tolerance threshold value, depending on the magnitude of the difference, the wheel braking pressure on the tires on one side is increased in such a way that a yaw moment contrary to the current actual yaw moment is generated.

The advantage of the ESP regulation according to the present invention over that in the related art is that inaccuracies in the wheel-force adjustment caused by the influence of disturbances in the hydraulics model (due for example to inaccurate modeling), in the hydraulics assembly (due for example to errors and corruption caused by temperature), on wheels or tires (due for example to glazed brake linings and worn tires) do not have to wait for correction by the ESP regulating system through the motion of the vehicle, but may be adjusted directly by the underlying yaw moment regulating circuit. This results in increased driving stability.

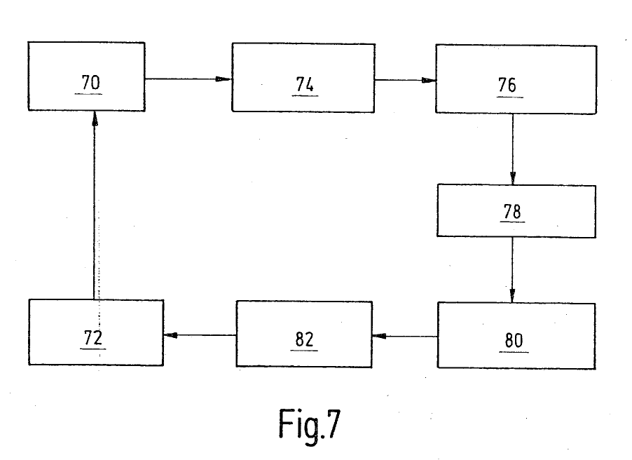

FIG. 7 shows a system representation of an ABS regulating device according to the related art. An ABS regulating device 70 receives wheel rotational speeds, i.e., wheel velocities as input variables from wheel rotational speed sensors 72, and calculates from them target braking forces as its output variables, which are output to a module for yaw moment reduction or yaw moment buildup delay device 74. Yaw moment buildup delay device 74 analyzes whether the required target braking forces will result in an undesirably high yaw moment, and if the yaw moment expected from the target braking forces exceeds a threshold value the yaw moment buildup delay device reduces one or more target braking forces. Yaw moment buildup delay device 74 does so by calculating the resultant yaw moment from the target braking forces, based on distances of the individual wheels from the center of gravity of the vehicle or from a yaw axis running though the center of gravity of the vehicle which are stored in a memory device.

The target braking forces, possibly reduced by yaw moment buildup delay device 74, are output to a model module 76, in which a hydraulics model is stored. Model module 76 determines the valve control signals needed to implement the target braking forces, as well as the other needed hydraulic activation, and outputs these to a hydraulics assembly 73 which activates the hydraulics, so that braking forces are generated at wheels or tires 80. The braking forces at wheels/tires 80 generate tire forces which act on vehicle 82 and thereby cause a change in the vehicle movement, which is detected by wheel rotational speed sensors 72. That closes the ABS regulating circuit.

Controlled system 76-78-80-82 corresponds to controlled system 46-48-50 52 in FIGS. 5 and 6; the description thereof is referred to specifically here.

A disadvantage of the ABS regulating circuit of the related art is that yaw moment buildup delay device 74 merely determines an anticipated yaw moment from the target braking forces calculated by ABS regulating device 70. No comparison with an actually occurring actual yaw moment takes place, so that inaccuracies in reducing target braking forces are unavoidable.

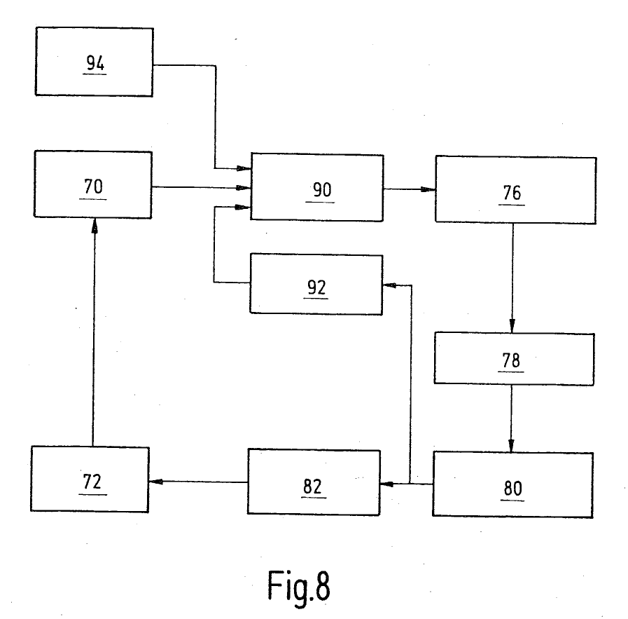

FIG. 8 therefore shows a system representation of an ABS control circuit using an embodiment of the system according to the present invention. Since the ABS regulating circuit shown in FIG. 8 corresponds in its elements 70, 72, 76, 78, 80 and 82 to the ABS regulating circuit in FIG. 7, in regard to those elements reference is made to the description given in reference to FIG. 7. Only the differences between the ABS regulating circuits in FIGS. 7 and 8 will be explained below.

In place of yaw moment buildup delay device 74, the ABS regulating circuit in FIG. 8 contains a yaw moment buildup delay device 90, which is based on a yaw moment regulating system. Yaw moment buildup delay device 90 receives as its input variable an actual yaw moment from a calculation module 92. Calculation module 92 may include for example wheel-force sensor devices and an evaluation device. Thus the tire forces acting on the wheels/tires 80 are detected and from them the actually occurring actual yaw moment of the vehicle is calculated. Either distances from the tires to the center of gravity of the vehicle or to a yaw axis running through the center of gravity of the vehicle, stored in a memory device, are used, or these distances are calculated on the basis of detected tire contact forces. Advantageously, both circumferential and transverse wheel-forces are detected, since this permits the most accurate calculation of the actual yaw moment.

Besides the actual yaw moment, yaw moment buildup delay device 90 receives a maximum target yaw moment as an input variable, which is calculated by a second calculation module 94.

Calculation module 94 predetermines the maximum target yaw moment from certain input signals (not shown). This predetermination may under certain circumstances be time-dependent, in order for example to not demand too much of a driver on split-μ roadways while still ensuring as short a braking path as possible.

By comparing the actual yaw moment to the maximum target yaw moment, yaw moment buildup delay device 90 may then limit the required target braking forces by bringing the actual yaw moment closer to the target yaw moment.

According to another alternative, yaw moment buildup delay device 90 may operate at first like the conventional yaw moment buildup delay device 70, i.e., calculating an anticipated yaw moment from the target braking forces output by ABS regulating device 70 and comparing it to a target value. If a permissible yaw moment is then exceeded by the yaw moment caused by the target braking forces, the yaw moment regulating system described above then takes effect, in which the actual yaw moment and the calculated target yaw moment are compared and result in a corresponding restriction of the target braking forces.

The advantage of the ABS regulating device shown in FIG. 8 is that first the yaw moment target value calculation can be kept simpler than the controlled yaw moment limitation via limitation of the wheel braking forces. In addition, with the help of such an underlying yaw moment regulating circuit it is possible to perform an intervention adapted to the then prevailing driving situation, since the actually effective actual yaw moment is determined, and not a compromise intended to meet the needs of as many driving situations as possible used as the basis, as in the approach of the related art. This involves the predictable advantages of a regulating system over a control system.

As an additional advantage, with the yaw moment target value specification it is possible to adjust the demand on the driver directly, independently of interfering influences such as different coefficients of friction of the brake lining, changing coefficients of friction of the roadway, different temperatures of the tires and/or the roadway, steering angle, etc., since these influences are compensated for by regulating the yaw moment.

The preceding description of the examples of embodiments according to the present invention is intended only for purposes of illustration, and not to limit the invention. Various changes and modifications are possible within the framework of the present invention, without going outside of the scope of the invention and its equivalents.

What is claimed is:

1. A system for monitoring the handling properties of a motor vehicle having at least two wheels (12), comprising:
at least one wheel-force sensor device (10) associated with a wheel (12), which device detects at least one wheel-force component of the respective wheel (12) acting essentially between the driving surface and the tire contact area and outputs a signal (Si, Sa) representing the wheel-force component; and
an evaluation device (14) which processes the signal (Si, Sa) representing the wheel-force component of the wheel (12),
wherein the evaluation device (14) determines a yaw moment of the vehicle on the basis of the processing result.

2. The system as recited in claim 1, wherein a wheel-force sensor device (10) is associated with each wheel (12) of the vehicle.

3. The system as recited in claim 1 or 2, wherein the wheel-force component acting essentially between the driving surface and the tire contact area is a circumferential wheel-force or a transverse wheel-force, preferably a circumferential wheel-force and a transverse wheel-force, particularly preferably a circumferential wheel-force, a transverse wheel-force, and a tire contact force.

4. The system as recited in one of the preceding claims, wherein it includes a memory device (15) for storing the detected yaw moments.

5. The system as recited in one of the preceding claims, wherein
the evaluation device (14) outputs a control signal according to the detected yaw moment, and
the system also includes a control device (16) that influences an operating condition of the motor vehicle according to the control signal.

6. The system as recited in one of the preceding claims, wherein the control device (16) modifies the engine power and/or a wheel braking pressure of at least one wheel (12) according to the control signal from the evaluation device (14).

7. The system as recited in one of the preceding claims, wherein the evaluation device (14) and/or the control device (16) is or are associated with a device for controlling and/or regulating the handling properties of a motor vehicle, such as for example an Antilock Brake System, a Traction Control System, or an ESP system.

8. The system as recited in one of the preceding claims, wherein the device for controlling and/or regulating the handling properties of a motor vehicle, in particular an Antilock Brake System, a Traction Control System, or an ESP system, includes a yaw moment regulating circuit that compares the yaw moment determined to a target yaw moment, and as a function of the comparison determines target wheel-forces which are to be exerted on at least one wheel (12) by the control device (16).

9. The system as recited in one of the preceding claims, wherein the yaw moment regulating circuit in an antilock brake system is a yaw moment reduction or yaw moment buildup delay circuit (74).

10. The system as recited in one of the preceding claims, wherein the sensor device (10) is a tire sensor device (20, 22, 24, 26, 28, 30).

11. The system as recited in one of the preceding claims, wherein the sensor device (10) is a wheel bearing sensor device.

12. A system for controlling and/or regulating the handling properties of a motor vehicle having at least one tire and/or one wheel (12), a force sensor (20, 22) being positioned in the tire and/or on the wheel (12), in particular on the wheel bearing, and a yaw moment variable representing the current yaw moment being determined as a function of the output signals from the force sensor (20, 22), this yaw moment variable being used for controlling and/or regulating the handling properties.

13. A method of monitoring the handling properties of a motor vehicle having at least two wheels (12), comprising the following steps:
detection of at least one wheel-force component of the particular wheel operating essentially between the driving surface and the tire contact area (S01, S02), and
processing of the detected wheel-force component of the wheel (S03, S04),
wherein the method also comprises the following step:
determination of a yaw moment of the vehicle according to the result of the processing (S05).

14. The method as recited in claim 13, wherein at each wheel (12) of the vehicle at least one wheel-force component acting between the driving surface and the tire contact area is detected.

15. The method as recited in claim 13 or 14, wherein a circumferential wheel-force or a transverse wheel-force, preferably a circumferential wheel-force and a transverse wheel-force, particularly preferably a circumferential wheel-force and a transverse wheel-force and a tire contact force are detected as the wheel-force component acting essentially between the driving surface and the tire contact area (S02).

16. The method as recited in one of claims 13 through 15, wherein the calculated yaw moment is stored in a memory device (15).

17. The method as recited in one of claims 13 through 16, wherein the following step is included:
influencing an operating condition of the motor vehicle according to the calculated yaw moment (S07, S08).

18. The method as recited in one of claims 13 through 17, wherein the step of influencing the operating condition of the motor vehicle includes a change in the engine power and/or in the wheel braking pressure of at least one wheel (12).

19. The method as recited in one of claims 13 through 18, wherein the influencing of the operating condition of the motor vehicle is carried out by a device for controlling and/or regulating the handling properties of a motor vehicle, such as an Antilock Brake System, a Traction Control System, or an ESP system.

20. The method as recited in one of claims 13 through 19, wherein the following steps are included:
comparing the calculated yaw moment to a target yaw moment (S06), and
determining target wheel-forces which are to be exerted on at least one wheel, as a function of the result of the comparison (S07).

21. The method as recited in one of claims 13 through 21, wherein the at least one wheel-force component acting essentially between the driving surface and the tire contact area is detected at a wheel, in particular on a tire of the wheel (12).

22. The method as recited in one of claims 13 through 22, wherein the at least one wheel-force component acting essentially between the driving surface and the tire contact area is detected at a wheel bearing.
